(19) United States
(12) Patent Application Publication
(10) Pub. No.: US 2007/0066742 A1
(43) Pub. Date: Mar. 22, 2007

(54) Reinforced styrenic resin composition, method, and article

(76) Inventors: Vijay Mhetar, Slingerlands, NY (US); William Eugene Pecak, Cohoes, NY (US); Alex Dimitri Sokolowski, Albany, NY (US)

Correspondence Address: CANTOR COLBURN, LLP, 55 GRIFFIN ROAD SOUTH, BLOOMFIELD, CT, 06002, US

(21) Appl. No.: 11/232,628

(22) Filed: Sep. 22, 2005

(51) Int. Cl. C08K 3/22

(52) U.S. Cl. 524/433; 524/502; 524/494; 524/493; 524/451; 524/449; 524/437

(57) ABSTRACT

A thermoplastic resin composition includes an amorphous poly(alkenyl aromatic) resin, an acid-functionalized poly(arylene ether), and an aminosilane-treated inorganic filler. The composition exhibits improved stiffness, impact strength, and tensile properties relative to other filled amorphous poly(alkenyl aromatic) resin compositions.

### BACKGROUND OF THE INVENTION

Filled and reinforced poly(alkenyl aromatic) resin compositions are presently employed in a variety of product applications, including automotive interior and under-the-hood components, appliance components, housings and covers, and packaging. Adding a reinforcing filler to a poly(alkenyl aromatic) resin composition typically improves the stiffness and heat resistance of articles molded from the composition. However, impact strength and tensile elongation properties are often degraded. The property balance can be improved by surface treating the filler with a silane coupling agent prior to incorporating the filler into the resin composition. However, further improvements in property tradeoffs are desired.

### BRIEF DESCRIPTION OF THE INVENTION

The above-described and other drawbacks are alleviated by a composition comprising an amorphous poly(alkenyl aromatic) resin, an acid-functionalized poly(arylene ether), and an aminosilane-treated inorganic filler.

Other embodiments, including a method of preparing the composition and an article prepared from the composition, are described in detail below.

### DETAILED DESCRIPTION OF THE INVENTION

One embodiment is a composition comprising an amorphous poly(alkenyl aromatic) resin, an acid-functionalized poly(arylene ether), and an aminosilane-treated inorganic filler. After extensive investigations, the present inventors have found that substantial and surprising property improvements are obtained when an acid-functionalized poly(arylene ether) and an aminosilane-treated inorganic filler are incorporated into an amorphous poly(alkenyl aromatic) resin. As demonstrated in the working examples below, the present compositions provide improvements in stiffness, impact strength, heat resistance, and tensile properties. Furthermore, the improvements are observed in a wide variety of amorphous poly(alkenyl aromatic) resins.

The composition comprises an amorphous poly(alkenyl aromatic) resin. An amorphous resin is a polymer resin that is lacking positional order on the molecular scale. It is distinguished from semicrystalline and crystalline resins, which do exhibit positional order on the molecular scale. The amorphous poly(alkenyl aromatic) resin comprises at least 25 percent by weight of structural units derived from an alkenyl aromatic monomer of the formula 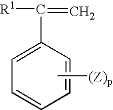
wherein R¹ is hydrogen, C₁-C₈ alkyl, or halogen; each occurrence of Z is independently vinyl, halogen, C₁-C₈ alkyl, or the like; and p is 0, 1, 2, 3, 4, or 5. The weight percent of alkenyl aromatic structural units may be at least about 30 weight percent, or at least about 50 weight percent, or at least about 70 weight percent.

Preferred alkenyl aromatic monomers include styrene, chlorostyrenes such as p-chlorostyrene, and methylstyrenes such as α-methylstyrene and p-methylstyrene. The poly(alkenyl aromatic) resins include homopolymers of an alkenyl aromatic monomer; random, graft, and block copolymers of two or more different alkenyl aromatic monomers; random, graft, and block copolymers of an alkenyl aromatic monomer with one or more different monomers such as acrylonitrile, butadiene, and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ nonaromatic diene monomer, such as butadiene or isoprene. In one embodiment the amorphous poly(alkenyl aromatic) resin comprises a rubber-modified polystyrene. In another embodiment, the amorphous poly(alkenyl aromatic) resin comprises an atactic homopolystyrene. In another embodiment, the amorphous poly(alkenyl aromatic) resin comprises a block copolymer of an alkenyl aromatic compound and a conjugated diene. Such block copolymers include hydrogenated block copolymers of an alkenyl aromatic compound and a conjugated diene such as, for example, a styrene-(ethylene-butylene)-styrene triblock copolymer. In one embodiment, the amorphous poly(alkenyl aromatic) resin comprises a styrene-(ethylene-butylene)-styrene triblock copolymer having a styrene content of about 25 to about 90 weight percent. Within this range, the styrene content may be at least about 35 weight percent. Also within this range, the styrene content may be up to about 80 weight percent, or up to about 75 weight percent, or up to about 67 weight percent. In another embodiment, a high-styrene triblock copolymer is preferred, and the amorphous poly(alkenyl aromatic) resin comprises a styrene-(ethylene-butylene)-styrene triblock copolymer having a styrene content of about 40 to about 90 weight percent. Within this range, the styrene content may be at least about 50 weight percent, or at least about 55 weight percent. Also within this range, the styrene content may be up to about 80 weight percent, or up to about 75 weight percent.

The composition may comprise about 10 to about 98 weight percent of the amorphous poly(alkenyl aromatic) resin, based on the total weight of the composition. Within this range, the poly(alkenyl aromatic) resin amount may be at least about 30 weight percent, or at least about 50 weight percent. Also within this range, the poly(alkenyl aromatic) resin amount may be up to about 95 weight percent, or up to about 90 weight percent.

In addition to the poly(alkenyl aromatic) resin, the composition comprises an acid-functionalized poly(arylene ether). A convenient method of preparing the acid-functionalized poly(arylene ether) is by reacting a poly(arylene ether) and an acid compound selected from (a) aliphatically unsaturated acid compounds comprising at least one carboxylic acid or anhydride group and at least one carbon-carbon double bond or carbon-carbon triple bond, and (b) polyfunctional acid compounds having the structure
(R³O)R²(COOR⁴)ₙ
wherein R² is a linear or branched chain, saturated aliphatic hydrocarbon having a valence of (n+1) and having 2 to 20, or, more specifically, 2 to 10, carbon atoms; R³ is hydrogen or an alkyl, aryl, or acyl group having 1 to 10, or, more specifically, 1 to 6, or, even more specifically, 1 to 4 carbon atoms; each R⁴ is independently hydrogen or an alkyl or aryl group having 1 to 20, or, more specifically, 1 to 10 carbon atoms; n is greater than or equal to 2, or, more specifically, equal to 2 or 3; wherein (OR³) is alpha or beta to at least one carbonyl group; and wherein at least two carbonyl groups are separated by 2 to 6 carbon atoms. Suitable aliphatically unsaturated acid compounds include, for example, fumaric acid, maleic acid, maleic anhydride, itaconic acid, itaconic anhydride, and the like, and combinations thereof. Suitable polyfunctional acid compounds include, for example, citric acid, malic acid, agaricic acid, and the like, and combinations thereof. Combinations of aliphatically unsaturated acid compounds and polyfunctional acid compounds may be used. In one embodiment, the acid compound is selected from fumaric acid, maleic acid, maleic anhydride, itaconic acid, itaconic anhydride, and combinations thereof. In one embodiment, the acid compound comprises fumaric acid.

This reaction between the poly(arylene ether) and the acid compound may be carried out in solution. Alternatively, the reaction may be carried out in a poly(arylene ether) melt. The poly(arylene ether) starting material, sometimes referred to as an “unfunctionalized” poly(arylene ether), comprises a plurality of structural units of the formula 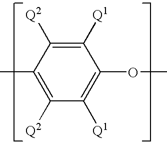
wherein for each structural unit, each Q¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each Q² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms. In one embodiment, the poly(arylene ether) is selected from poly(2,6-dimethyl-1,4-phenylene ether), poly(2,6-dimethyl-1,4-phenylene ether-co-2,3,6-trimethyl-1,4-phenylene ether), and mixtures thereof.

The reaction between the poly(arylene ether) and the acid compound may be facilitated by a free radical initiator. Free radical initiators generally include compounds capable of generating free radicals at the reaction temperature of the poly(arylene ether) and the acid compound. Such free radical initiators may include peroxy compounds. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and combinations thereof.

The acid compound may be used in an amount of about 0.1 to about 25 weight percent, relative to the weight of the poly(arylene ether). As illustrated by the working examples below, the weight percent of acid functionality incorporated into the acid-functionalized poly(arylene ether) resin as grafts is fairly insensitive to the acid compound amount. Depending on the specific reaction conditions chosen, the acid-functionalized poly(arylene ether) may comprise about 0.05 to about 10 weight percent of acid functionality, measured as the weight of incorporated acid compound. Within this range, the weight percent of acid functionality may be at least about 0.1 weight percent, or at least about 0.2 weight percent. Also within this range, the weight percent of acid functionality may be up to about 5 weight percent, or up to about 2 weight percent. The weight percent of acid functionality may be determined as described in the working examples for Preparative Examples 1-18.

Acid functionalized poly(arylene ether) resins with a wide variety of molecular weights and intrinsic viscosities may be used. For example, the acid-functionalized poly(arylene ether) may have an intrinsic viscosity of about 0.06 to about 0.6 deciliters per gram, measured at 25° C. in chloroform. In one embodiment, the acid-functionalized poly(arylene ether) may have an intrinsic viscosity of about 0.12 to about 0.46 deciliters per gram.

The composition may comprise about 0.5 to about 40 weight percent of the acid-functionalized poly(arylene ether), based on the total weight of the composition. Within this range, the acid-functionalized poly(arylene ether) amount may be at least about 1 weight percent, or at least about 2 weight percent. Also within this range, the acid-functionalized poly(arylene ether) amount may be up to about 20 weight percent, or up to about 15 weight percent.

In addition to the poly(alkenyl aromatic) resin and the acid-functionalized poly(arylene ether), the composition comprises an aminosilane-treated inorganic filler. The inorganic filler may have a surface capable of forming a covalent bond with an aminosilane coupling agent. Suitable fillers include, for example, glass fibers, glass spheres, glass flakes, wollastonite, silica, boron-silicate powders, quartz, alumina, magnesium oxide, talc, mica, kaolin, aluminum trihydrate, magnesium hydroxide, and the like, and combinations thereof.

The inorganic filler is aminosilane-treated. Aminosilanes used to treat the inorganic filler are known in the art and generally contain at least one C₁-C₆ alkoxy group and at least one primary, secondary, or tertiary amine group. These silanes may be characterized as compounds having in a single molecule one or more hydrolytic groups which in the presence of water generate silanol groups capable of forming covalent bonds with free surface hydroxyl groups on the filler surface via condensation reactions. Also present in the aminosilane molecule are primary, secondary, or tertiary amine groups that are capable of forming covalent bonds with the acid functionality in the acid-functionalized poly(arylene ether). In one embodiment, the aminosilane has the structure
(H₂N—R⁵)₄₋ₙSi(OR⁶)ₙ
wherein each occurrence of R⁵ is independently C₁-C₆ alkylene; each occurrence of R⁶ is independently C₁-C₆ alkyl; and n is 1, 2, or 3. Suitable aminosilanes include, for example, γ-aminopropyltriethoxysilane, γ-aminopropyltrimethoxysilane, N,β-(aminoethyl)-γ-aminopropyltrimethoxysilane, N,β-(aminoethyl)-γ-aminopropylmethyldimethoxysilane, N,β-(aminoethyl)-γ-aminopropyltriethoxysilane, γ-aminopropylmethyldiethoxysilane, γ-aminopropylmethyldimethoxysilane, and the like, and combinations thereof. In one embodiment, the aminosilane-treated inorganic filler comprises an inorganic filler surface treated with γ-aminopropyltriethoxysilane. The aminosilane-treated inorganic filler may comprise about 0.05 to about 5 weight percent of aminosilane-derived residue.

The composition may comprise about 1 to about 80 weight percent of the aminosilane-treated inorganic filler, based on the total weight of the composition. Within this range, the filler amount may be at least about 5 weight percent, or at least about 10 weight percent. Also within this range, the filler amount may be up to about 60 weight percent, or up to about 40 weight percent.

In addition to the amorphous poly(alkenyl aromatic) resin, the acid-functionalized poly(arylene ether), and the aminosilane-treated inorganic filler, the composition may, optionally, further comprise an unfunctionalized poly(arylene ether). The unfunctionalized poly(arylene ether) has the structure described above in the context of preparation of the acid-functionalized poly(arylene ether). When present, the unfunctionalized poly(arylene ether) may be used in an amount of about 1 to about 88 weight percent, based on the total weight of the composition. Within this range, the unfunctionalized poly(arylene ether) amount may be at least about 2 weight percent, or at least about 5 weight percent. Also within this range, the unfunctionalized poly(arylene ether) amount may be up to about 70 weight percent, or up to about 50 weight percent.

The composition may, optionally, further comprise various additives known in the art for thermoplastic compositions. For example, the composition may, optionally, further comprise one or more additives including, for example, plasticizers, impact modifiers, mold release agents, colorants (including pigments and dyes), thermal stabilizers, light stabilizers, antioxidants, drip retardants, antiblocking agents, antistatic agents, blowing agents, flame retardants, and the like, and combinations thereof.

One embodiment is a composition, comprising: an amorphous poly(alkenyl aromatic) resin selected from atactic homopolystyrenes, rubber-modified polystyrenes, and styrene-(ethylene-butylene)-styrene triblock copolymers; an acid-functionalized poly(arylene ether) that is the reaction product of a poly(arylene ether) and an acid compound selected from maleic acid, maleic anhydride, fumaric acid, itaconic acid, itaconic anhydride, and combinations thereof; and aminosilane-treated glass fibers.

One embodiment is a composition, comprising: about 30 to about 94 weight percent of an amorphous poly(alkenyl aromatic) resin selected from atactic homopolystyrenes, rubber-modified polystyrenes, and styrene-(ethylene-butylene)-styrene triblock copolymers; about 1 to about 20 weight percent of an acid-functionalized poly(arylene ether) that is the reaction product of a poly(arylene ether) and an acid compound selected from maleic acid, maleic anhydride, fumaric acid, itaconic acid, itaconic anhydride, and combinations thereof; and about 5 to about 50 weight percent of aminosilane-treated glass fibers; wherein the composition is substantially free of polyamide. When the composition is described as “substantially free” of a component, the composition will be understood to comprise less than 0.1 weight percent of the component. Preferably, the composition comprises less than 0.01 weight percent of the component. The composition preferably comprises no intentionally added amount of the component.

The composition may exclude any component not specifically disclosed as included or optionally included herein. For example, the composition may exclude crystalline and semicrystalline poly(alkenyl aromatic) resins (i.e., non-amorphous poly(alkenyl aromatic) resins) such as syndiotactic polystyrene. As another example, the composition may exclude polyamides. When a component is excluded, the composition is “substantially free” of that component, as defined above.

The invention includes methods of preparing the thermoplastic composition. Thus, one embodiment is a method of preparing a thermoplastic composition, comprising: blending an amorphous poly(alkenyl aromatic) resin, an acid-functionalized poly(arylene ether), and an aminosilane-treated inorganic filler to form an intimate blend. Acid-functionalization of the poly(arylene ether) may be conducted as part of the composition preparation. Thus, one embodiment is a method of preparing a thermoplastic composition, comprising: melt blending a poly(arylene ether) resin, and an acid compound comprising at least one carboxylic acid group and at least one carbon-carbon double bond, and, optionally, a free radical initiator, to form an acid-functionalized poly(arylene ether); and blending the acid-functionalized poly(arylene ether), an amorphous poly(alkenyl aromatic) resin, and an aminosilane-treated inorganic filler to form an intimate blend. In this embodiment, a single extruder run may be used to form the acid-functionalized poly(arylene ether) upstream and add the amorphous poly(alkenyl aromatic resin) and aminosilane-treated inorganic filler downstream. Alternatively, preparation of the acid-functionalized poly(arylene ether) may be conducted separately from blending of the acid-functionalized poly(arylene ether), the amorphous poly(alkenyl aromatic resin), and the aminosilane-treated inorganic filler. The blending steps in the above methods may be conducted via any thermoplastic blending technique capable of producing an intimate blend. For example, the amorphous poly(alkenyl aromatic) resin, the acid-functionalized poly(arylene ether), and the aminosilane-treated inorganic filler may be blended in solution followed by removal of solvent. Alternatively, the same components may be melt blended. Apparatus suitable for preparing thermoplastic blends via melt blending includes, for example, a two-roll mill, a Banbury mixer, and a single-screw or twin-screw extruder.

The invention extends to articles formed from the composition. Thus, one embodiment is an article comprising any of the above compositions. In particular, the article may comprise a film, sheet, molded object or composite having at least one layer comprising the composition. Techniques for fabricating articles from thermoplastic compositions include, for example, film and sheet extrusion, injection molding, gas-assist injection molding, extrusion molding, compression molding, blow molding, and the like.

The invention is further illustrated by the following non-limiting examples.

### PREPARATIVE EXAMPLES 1-18

These examples illustrate acid functionalization of a poly(arylene ether). An unfunctionalized poly(2,6-dimethyl-1,4-phenylene ether) resin having a number average molecular weight of about 15,800 atomic mass units (AMU) and a weight average molecular weight of about 54,000 AMU was obtained as NORYL® 630 from General Electric Company. This unfunctionalized poly(arylene ether) was melt blended with maleic anhydride or fumaric acid or citric acid in the amounts specified in Table 1, using a twin-screw extruder with a barrel temperature of 310° C. In some samples, a radical initiator was also added. The radical initiators were dicumyl peroxide (“DCP”) and 2,5-dimethyl-2,5-di-(t-butylperoxy)hexane (“DBPH”). The acid compound and radical initiator amounts are expressed in weight percent (“wt %”) relative to the poly(arylene ether) amount. The poly(arylene ether) and the acid compound were both added at the feed throat. The extruded products were analyzed by gel permeation chromatography to determine number average molecular weight and weight average molecular weight. The molecular weight determinations used monodisperse polystyrene standards, a styrene divinyl benzene gel at 40° C., and samples having a concentration of 1 milligram per milliliter of chloroform. Products were also analyzed by Fourier transform infrared spectroscopy (FTIR), using the C═O stretch at 1782 reciprocal centimeters (cm⁻¹) to determine the weight percent of incorporated acid. The intensity of the stretch at 1782 cm⁻¹ was used to calculate the amount of MA grafted onto PPO via a calibration curve. The standards, as well as the samples, were dissolved in chloroform and run in a liquid cell on a Nicolet Protégé 460 FTIR spectrometer. Standards were prepared by adding maleic anhydride to the poly(arylene ether)/chloroform solutions at levels that represented expected levels of grafting onto PPO. The carbonyl stretching from the unbound maleic anhydride in the standards is assumed to generate peaks in the same region and with the same intensity as the bound maleic anhydride functional groups on the PPO after extrusion (˜1782 cm⁻¹). Results are presented in Table 1. The results show that the weight percent of incorporated acid is only mildly sensitive to the amount of acid added. The results also show that the use of free radical initiator such as dicumyl peroxide or 2,5-dimethyl-2,5-di-(t-butylperoxy)hexane substantially increases the weight percent of incorporated acid.

TABLE 1

| | P. Ex. 1 | P. Ex. 2 | P. Ex. 3 | P. Ex. 4 | P. Ex. 5 |
|---|---|---|---|---|---|
| acid compound type | MA¹ | MA | MA | MA | MA |
| acid compound amount | 1.5 | 3.0 | 4.5 | 6.0 | 7.5 |
| (wt %) | | | | | |
| radical initiator type | — | — | — | — | — |
| radical initiator amount | — | — | — | — | — |
| (wt %) | | | | | |
| Mₙ (AMU) | 14575 | 13524 | 13995 | 12509 | 12608 |
| M_{W} (AMU) | 51972 | 47817 | 51383 | 44164 | 43343 |
| acid incorporation | 0.276 | 0.254 | 0.260 | 0.279 | 0.276 |
| amount (wt %) | | | | | |
| | P. Ex. 6 | P. Ex. 7 | P. Ex. 8 | P. Ex. 9 | P. Ex. |
| | | | | | 10 |
| acid compound type | MA | MA | FA² | FA | FA |
| acid compound amount | 4.5 | 4.5 | 1.5 | 3.0 | 4.5 |
| (wt %) | | | | | |
| radical initiator type | DBHP³ | DCP⁴ | — | — | — |
| radical initiator amount | 3.0 | 3.0 | — | — | — |
| (wt %) | | | | | |
| Mₙ (AMU) | 9610 | 9600 | 14331 | 12548 | 11551 |
| M_{W} (AMU) | 32913 | 34646 | 52500 | 43855 | 39593 |
| acid incorporation | 0.897 | 0.820 | 0.203 | 0.327 | 0.378 |
| amount (wt %) | | | | | |
| | P. Ex. | P. Ex. | P. Ex. | P. Ex. | P. Ex. |
| | 11 | 12 | 13 | 14 | 15 |
| acid compound type | FA | FA | FA | CA⁵ | CA |
| acid compound amount | 6.0 | 7.5 | 4.5 | | |
| (wt %) | | | | | |
| radical initiator type | — | — | DCP | — | — |
| radical initiator amount | — | — | 3.0 | — | — |
| (wt %) | | | | | |
| Mₙ (AMU) | 12018 | 11589 | 11660 | 15796 | 15509 |
| MW(AMU) | 41515 | 40349 | 44097 | 51084 | 51093 |
| acid incorporation | 0.292 | 0.256 | 0.591 | 0.098 | 0.136 |
| amount (wt %) | | | | | |

| | P. Ex. 16 | P. Ex. 17 | P. Ex. 18 |
|---|---|---|---|
| acid compound type | CA | CA | CA |
| acid compound amount (wt %) | 4.5 | 6.0 | 7.5 |
| radical initiator type | — | — | — |
| radical initiator amount (wt %) | — | — | — |
| Mₙ (AMU) | 15973 | 15623 | 15764 |
| M_{W} (AMU) | 55088 | 54386 | 51559 |
| acid incorporation amount | 0.130 | 0.133 | 0.126 |
| (wt %) | | | |

¹MA = maleic anhydride
²FA = fumaric acid
³DBHP = 2,5-dimethyl-2,5-di-(t-butylperoxy)hexane
⁴DCP = dicumyl peroxide
⁵CA = citric acid

### PREPARATIVE EXAMPLE 19

Ninety-eight parts by weight of poly(2,6-dimethyl-1,4-phenylene ether) having an intrinsic viscosity of 0.33 deciliters per gram at 25° C. in chloroform were mixed with 2 parts by weight of fumaric acid at room temperature in a high-speed, ten-liter Henschel mixer. The mixer was turned on at 50% power for 30 seconds. The blend was collected in a polyethylene bag and transferred to an upstream feed hopper on the extruder. The blend was fed from the feed hopper to the extruder, which was a 30 millimeter diameter intermeshing twin-screw extruder manufactured by Werner & Pfleiderer, having a 10-barrel configuration with a length to diameter (LID) ratio of 32:1. Compounding conditions were as follows: temperature profile from feed throat to die, 240° C./280° C./300° C./300° C./300° C./300° C.; screw rotations per minute (RPM), 325; total feed rate, 11.34 kilograms/hour (25 pounds/hour); vacuum vent at barrel 10 at a pressure of 85 kilopascals (25 inches of mercury). Material was passed through a strand die at the end of the extruder and the extruded strands were pelletized with a rotary strand-cut pelletizer.

### PREPARATIVE EXAMPLE 20

Maleic anhydride functionalized poly(arylene ether) was prepared according to the procedure of Preparative Example 19, using 2 parts by weight of maleic anhydride and 98 parts by weight of poly(2,6-dimethyl-1,4-phenylene ether) having an intrinsic viscosity of 0.33 deciliters per gram.

### EXAMPLES 1-7, COMPARATIVE EXAMPLES 1-12

These examples illustrate the effect on physical properties of acid-functionalized polymer type (i.e., acid-functionalized poly(arylene ether) versus a blend of poly(styrene-maleic anhydride) and HIPS), acid-functionalized poly(arylene ether) amount, filler type (glass fibers versus wollastonite versus silica), and filler treatment type (untreated wollastonite versus aminosilane-treated wollastonite). Compositions are presented in Table 2. Rubber-modified polystyrene (“HIPS”) having 10 weight percent rubber was obtained from General Electric Company. An unfunctionalized poly(arylene ether) (“PPE”), specifically a poly(2,6-dimethyl-1,4-phenylene ether) having an intrinsic viscosity of 0.33 deciliters per gram at 25° C. in chloroform, was obtained as NORYL® 630 from General Electric Company. A fumaric acid functionalized poly(arylene ether) (“FAPPE”) having a fumaric acid content of 0.26 weight percent was prepared according to the procedure of Preparative Example 19. Rubber modified styrene-maleic anhydride copolymer (“SMA-HIPS”) was obtained from General Electric Company. Aminosilane-treated glass fibers having a diameter of about 13.5 micrometers and an initial length of about 4 millimeters were obtained as 122Y from Owens Corning. Untreated wollastonite having median particle size of 2.2 microns and surface area of 4.0 meter-squared per gram (m²/g) was obtained as NYAD 5000 from Nyco Minerals. Aminosilane-treated wollastonite having median particle size of 2.2 microns and surface area of 4.0 m²/g was obtained as NYAD 5000-10014 from Nyco Minerals. Aminosilane-treated silica having average particle size of 1.4 microns was obtained as Burgess 2211 from Burgess Pigment.

Compositions were compounded by melt-blending in a 30 millimeter intermeshing twin-screw extruder manufactured by Werner & Pfleiderer. The extruder had a ten-barrel configuration with a length to diameter ratio of 32:1. Fiberglass was added downstream into barrel 7, whereas mineral fillers were added to the upstream feed hopper. Compounding conditions were as follows: temperature profile from feed throat to die: 240° C./260° C./280° C./280° C./290° C./290° C.; screw rotation rate 325 RPM; total feed rate 18 kilograms/hour (40 pounds/hour); vacuum vent employed at barrel 10 at a pressure of 85 kilopascals (25 inches of mercury). The compounded composition was pumped through a strand die and pelletized for injection molding. Test articles were injection molded on a 120 Ton Van Dorn injection molding machine configured with ASTM test part molds. The temperature of the molding machine barrel was 232° C. (450° F.), and the mold temperature was 65° C. (150° F.). Flexural modulus, flexural stress at yield, and flexural stress at break, all expressed in megapascals, were measured according to ASTM D790 on samples having thickness of 3.2 millimeters. Heat deflection temperature, expressed in ° C., was determined according to ASTM D648 on samples having thickness of 3.2 millimeters. Notched Izod impact strengths were determined according to ASTM D256. Tensile properties were determined according to ASTM D638.

Examples 1-3 and Comparative Examples 1-7 all use aminosilane treated glass fibers as inorganic filler. The results for these samples show that inventive samples Examples 1-3, with 2, 5, and 10 weight percent of fumaric acid functionalized poly(arylene ether), respectively, exhibit greater (more desirable) values of all properties tested than corresponding samples with unfunctionalized poly(arylene ether) (Comparative Examples 5-7), a blend of styrene-maleic anhydride copolymer and high impact polystyrene (Comparative Examples 2-4), or the no additive control (Comparative Example 1). Low levels of acid-functionalized poly(arylene ether) (2 weight percent fumaric-acid functionalized polyphenylene ether) produced the highest values of impact strength and modulus of elasticity. Moderate levels of acid-functionalized poly(arylene ether) (5 weight percent fumaric-acid functionalized polyphenylene ether) produced the highest values of tensile stress and elongation. And high levels of acid-functionalized poly(arylene ether) (10 weight percent fumaric acid functionalized polyphenylene ether) produced the highest values of flexural properties and heat deflection temperature.

Examples 4 and 5, and Comparative Examples 8-11 used wollastonite as the inorganic filler. The best property values were exhibited by the Examples 4 and 5, which included fumaric acid functionalized poly(arylene ether) and aminosilane-treated wollastonite. Note that the properties of these samples were superior to those of the corresponding sample without fumaric acid functionalized poly(arylene ether) (Comparative Example 11), and the corresponding samples with untreated wollastonite (Comparative Examples 9 and 10).

Examples 6 and 7, and Comparative Example 12 use aminosilane-treated silica as the inorganic filler. The best property values were exhibited by Examples 6 and 7, which included fumaric acid functionalized poly(arylene ether). Note that the properties of those samples were superior to those of the corresponding sample without fumaric acid functionalized poly(arylene ether) (Comparative Example 12).

TABLE 2

| | C. Ex. 1 | C. Ex. 2 | C. Ex. 3 | C. Ex. 4 | C. Ex. 5 |
|---|---|---|---|---|---|
| Composition | | | | | |
| HIPS | 80.00 | 78.00 | 75.00 | 70.00 | 78.00 |
| PPE | — | — | — | — | 2.00 |
| FAPPE | — | — | — | — | — |
| SMA-HIPS | — | 2.00 | 5.00 | 10.00 | — |
| Aminosilane-treated | 20.00 | 20.00 | 20.00 | 20.00 | 20.00 |
| glass fibers | | | | | |
| Wollastonite, untreated | — | — | — | — | — |
| Wollastonite, amino- | — | — | — | — | — |
| silane treated | | | | | |
| Silica, aminosilane | — | — | — | — | — |
| treated | | | | | |
| Properties | | | | | |
| Flexural modulus (MPa) | 5183 | 5339 | 5559 | 5572 | 5245 |
| Flexural stress at yield | 56.0 | 90.5 | 97.9 | 102.0 | 83.3 |
| (MPa) | | | | | |
| Flexural stress at break | 54.0 | 89.7 | 97.2 | 86.6 | 81.9 |
| (MPa) | | | | | |
| Heat deflection | 95.9 | 97.0 | 97.8 | 98.1 | 100.4 |
| temperature (° C.) | | | | | |
| Notched Izod impact | 68.6 | 82.7 | 94.1 | 95.3 | 87.4 |
| strength (J/m) | | | | | |
| Modulus of elasticity | 6274 | 6522 | 6622 | 6388 | 6476 |
| (MPa) | | | | | |
| Tensile stress at yield | 42.6 | 67.1 | 68.2 | 68.3 | 58.4 |
| (MPa) | | | | | |
| Tensile stress at break | 42.64 | 67.08 | 68.16 | 68.28 | 58.4 |
| (MPa) | | | | | |
| Tensile elongation at | 0.97 | 2.04 | 2.06 | 2.14 | 1.60 |
| break (%) | | | | | |
| | C. Ex. 6 | C. Ex. 7 | Ex. 1 | Ex. 2 | Ex. 3 |
| Composition | | | | | |
| HIPS | 75.00 | 70.00 | 78.00 | 75.00 | 70.00 |
| PPE | 5.00 | 10.00 | — | — | — |
| FAPPE | — | — | 2.00 | 5.00 | 10.00 |
| SMA-HIPS | — | — | — | — | — |
| Aminosilane-treated | 20.00 | 20.00 | 20.00 | 20.00 | 20.00 |
| glass fibers | | | | | |
| Wollastonite, untreated | — | — | — | — | — |
| Wollastonite, amino- | — | — | — | — | — |
| silane treated | | | | | |
| Silica, aminosilane | — | — | — | — | — |
| treated | | | | | |
| Properties | | | | | |
| Flexural modulus (MPa) | 5245 | 5464 | 5475 | 5537 | 5630 |
| Flexural stress at yield | 71.3 | 87.3 | 105.3 | 109.2 | 116.5 |
| (MPa) | | | | | |
| Flexural stress at break | 70.1 | 86.1 | 104.5 | 108.4 | 115.3 |
| (MPa) | | | | | |
| Heat deflection | 102.4 | 108.2 | 99.5 | 102.5 | 109.0 |
| temperature (° C.) | | | | | |
| Notched Izod impact | 64.9 | 66.7 | 121.4 | 116.0 | 114.8 |
| strength (J/m) | | | | | |
| Modulus of elasticity | 6790 | 6688 | 7824 | 6696 | 5258 |
| (MPa) | | | | | |
| Tensile stress at yield | 52.4 | 62.9 | 72.2 | 73.7 | 61.7 |
| (MPa) | | | | | |
| Tensile stress at break | 52.4 | 62.9 | 72.16 | 73.7 | 61.7 |
| (MPa) | | | | | |
| Tensile elongation at | 1.20 | 1.52 | 2.30 | 2.30 | 0.66 |
| break (%) | | | | | |
| | C. Ex. 8 | C. Ex. 9 | C. Ex. | C. Ex. | Ex. 4 |
| | | | 10 | 11 | |
| Composition | | | | | |
| HIPS | 80.00 | 78.00 | 75.00 | 80.00 | 78.00 |
| PPE | — | — | — | — | — |
| FAPPE | — | 2.00 | 5.00 | — | 2.00 |
| SMA-HIPS | — | — | — | — | — |
| Aminosilane-treated | — | — | — | — | — |
| glass fibers | | | | | |
| Wollastonite, untreated | 20.00 | 20.00 | 20.00 | — | — |
| Wollastonite, amino- | — | — | — | 20.00 | 20.00 |
| silane treated | | | | | |
| Silica, aminosilane | — | — | — | — | — |
| treated | | | | | |
| Properties | | | | | |
| Flexural modulus (MPa) | 3856 | 3954 | 3737 | 4218 | 4553 |
| Flexural stress at yield | 46.5 | 45.7 | 45.1 | 51.6 | 81.6 |
| (MPa) | | | | | |
| Flexural stress at break | — | — | — | — | — |
| (MPa) | | | | | |
| Heat deflection | 90.3 | 92.1 | 94.7 | 94.1 | 97.3 |
| temperature (° C.) | | | | | |
| Notched Izod impact | 92.6 | 93.6 | 90.2 | 105.5 | 163.8 |
| strength (J/m) | | | | | |
| Modulus of elasticity | — | — | — | — | — |
| (MPa) | | | | | |
| Tensile stress at yield | 32.6 | 34.6 | 35.1 | 37.1 | 52.2 |
| (MPa) | | | | | |
| Tensile stress at break | 32.6 | 34.6 | 35.1 | 37.1 | 52.2 |
| (MPa) | | | | | |
| Tensile elongation at | 8.7 | 8.6 | 9.8 | 10.5 | 16.4 |
| break (%) | | | | | |

| | Ex. 5 | C. Ex. 12 | Ex. 6 | Ex. 7 |
|---|---|---|---|---|
| Composition | | | | |
| HIPS | 75.00 | 80.00 | 78.00 | 75.00 |
| PPE | — | — | — | — |
| FAPPE | 5.00 | — | 2.00 | 5.00 |
| SMA-HIPS | — | — | — | — |
| Aminosilane-treated glass fibers | — | — | — | — |
| Wollastonite, untreated | — | — | — | — |
| Wollastonite, aminosilane treated | 5.00 | — | — | — |
| Silica, aminosilane treated | — | 20.00 | 20.00 | 20.00 |
| Properties | | | | |
| Flexural modulus (MPa) | 4497 | 2600 | 2938 | 2950 |
| Flexural stress at yield (MPa) | 82.5 | 44.9 | 50.2 | 52.5 |
| Flexural stress at break (MPa) | — | — | — | — |
| Heat deflection temperature (° C.) | 101.6 | 54.1 | 82.3 | 86.4 |
| Notched Izod impact strength (J/m) | 165.1 | 50.4 | 74.7 | 70.7 |
| Modulus of elasticity (MPa) | — | — | — | — |
| Tensile stress at yield (MPa) | 54.7 | 31.4 | 33.6 | 35.8 |
| Tensile stress at break (MPa) | 54.7 | 27.6 | 28.9 | 31.6 |
| Tensile elongation at break (%) | 17.9 | 12.0 | 15.0 | 14.0 |

### EXAMPLES 8-15, COMPARATIVE EXAMPLES 13-16

These examples illustrate the effects of amorphous poly(alkenyl aromatic) resin type, acid functionalized poly(arylene ether) type, acid functionalized poly(arylene ether) intrinsic viscosity, and glass fiber treatment type. Compositions are presented in Table 3. A poly(styrene-(ethylene-butylene)-styrene) triblock copolymer (“SEBS KG1650”) having a polystyrene content of about 30 weight percent was obtained as KRATON® G1650 from Kraton Polymers. A poly(styrene-(ethylene-butylene)-styrene) triblock copolymer (“SEBS TH1043”) having a polystyrene content of about 66 weight percent was obtained as TUFTEC® H1043 from Asahi Chemical. A poly(2,6-dimethyl-1,4-phenylene ether) having an intrinsic viscosity of 0.33 deciliters per gram at 25° C. in chloroform (“0.33 IV PPE”), was obtained as NORYL® 630 from General Electric Company. Fumaric acid functionalized poly(2,6-dimethyl-1,4-phenylene ether)s were prepared according to the procedure of Preparative Example 19, above. A maleic anhydride functionalized poly(2,6-dimethyl-1,4-phenylene ether) was prepared according to the procedure of Preparative Example 20, above. Aminosilane-treated glass fibers having a diameter of about 13.5 micrometers and an initial length of about 4 millimeters were obtained as 122Y from Owens Corning. Epoxysilane-treated glass fibers having a diameter of about 10 micrometers and an initial length of about 4.5 millimeters were obtained as ChopVantage® HP3540 from PPG Industries.

Compositions and results are presented in Table 3. Examples 8, 10, and 11 all include HIPS as the amorphous poly(alkenyl aromatic) resin and aminosilane-treated glass fibers as the filler, and they vary in the intrinsic viscosity of the fumaric acid functionalized poly(arylene ether). The results show that Example 10, with a FAPPE intrinsic viscosity of 0.12, is slightly less effective than Examples 8 and 11, with FAPPE intrinsic viscosities of 0.33 and 0.46. Comparison of Examples 8 and 9 shows that FAPPE and MAPPE at 2 weight percent produce fairly similar properties in a composition with HIPS and aminosilane-treated glass fibers. Comparison of Examples 12 and 13, and Comparison Example 15, show that FAPPE at 2 and 5 weight percent improves the properties of a composition with aminosilane-treated glass fibers and a poly(styrene-(ethylene-butylene)-styrene) triblock copolymer having 30% polystyrene. Comparison of Examples 14 and 15, and Comparative Example 16 show that that FAPPE at 2 and 5 weight percent improves the properties of a composition with aminosilane-treated glass fibers and a poly(styrene-(ethylene-butylene)-styrene) triblock copolymer having 66% polystyrene. Comparison of Example 8 and Comparative Example 14 shows properties are much better for aminosilane-treated glass versus epoxysilane-treated glass in a composition with HIPS and FAPPE.

TABLE 3

| | Ex. 8 | Ex. 9 | Ex. 10 | Ex. 11 | C. Ex. |
|---|---|---|---|---|---|
| | | | | | 13 |
| Composition | | | | | |
| HIPS | 78.00 | 78.00 | 78.00 | 78.00 | 78.00 |
| SEBS KG1650 | — | — | — | — | — |
| SEBS TH1043 | — | — | — | — | — |
| 0.33 IV PPE | — | — | — | — | — |
| 0.33 IV FAPPE | 2.00 | — | — | — | 2.00 |
| 0.33 IV MAPPE | — | 2.00 | — | — | — |
| 0.12 IV FAPPE | — | — | 2.00 | — | — |
| 0.46 IV FAPPE | — | — | — | 2.00 | — |
| glass fiber, aminosilane | 20.00 | 20.00 | 20.00 | 20.00 | — |
| treated | | | | | |
| glass fiber, epoxysilane | — | — | — | — | 20.00 |
| treated | | | | | |
| Properties | | | | | |
| Flexural modulus (MPa) | 5200 | 5120 | 5220 | 5110 | 5150 |
| Flexural stress at yield | 113.0 | 109.0 | 78.9 | 114.0 | 67.1 |
| (MPa) | | | | | |
| Flexural stress at break | 113.0 | 109.0 | 78.6 | 114.0 | 65.3 |
| (MPa) | | | | | |
| Heat deflection | 97.2 | 97.4 | 96.6 | 97.8 | 92.8 |
| temperature (° C.) | | | | | |
| Notched Izod impact | 125.0 | 125.0 | 63.4 | 125.0 | 74.0 |
| strength (J/m) | | | | | |
| Tensile stress at yield | 75.2 | 73.0 | 64.9 | 78.2 | 62.5 |
| (MPa) | | | | | |
| Tensile stress at break | 75.2 | 73.0 | 64.9 | 78.2 | 62.5 |
| (MPa) | | | | | |
| Tensile elongation at | 2.3 | 2.3 | 1.3 | 2.4 | 1.4 |
| break (%) | | | | | |

| | C. Ex. | Ex. 12 | Ex. 13 | C. Ex. |
|---|---|---|---|---|
| | 14 | | | 15 |
| Composition | | | | |
| HIPS | 80.00 | — | — | — |
| SEBS KG1650 | — | 78.00 | 75.00 | 80.00 |
| SEBS TH1043 | — | — | — | — |
| 0.33 IV PPE | — | 2.00 | 5.00 | — |
| 0.33 IV FAPPE | — | — | — | — |
| 0.33 IV MAPPE | — | — | — | — |
| 0.12 IV FAPPE | — | — | — | — |
| 0.46 IV FAPPE | — | — | — | — |
| glass fiber, aminosilane treated | — | 20.00 | 20.00 | 20.00 |
| glass fiber, epoxysilane treated | 20.00 | — | — | — |
| Properties | | | | |
| Flexural modulus (MPa) | 4470 | 225 | 237 | 153 |
| Flexural stress at yield (MPa) | 53.7 | — | — | — |
| Flexural stress at break (MPa) | 44.3 | — | — | — |
| Heat deflection temperature | 88.5 | 49.8 | 52.5 | 45.3 |
| (° C.) | | | | |
| Notched Izod impact strength | 61.0 | 203.0 | 241.0 | 124.0 |
| (J/m) | | | | |
| Tensile stress at yield (MPa) | 50.9 | 10.9 | 11.7 | 7.5 |
| Tensile stress at break (MPa) | 50.9 | — | — | — |
| Tensile elongation at break | 1.0 | — | — | — |
| (%) | | | | |

| | Ex. 14 | Ex. 15 | C. Ex. 16 |
|---|---|---|---|
| Composition | | | |
| HIPS | — | — | — |
| SEBS KG1650 | — | — | — |
| SEBS TH1043 | 78.00 | 75.00 | 80.00 |
| 0.33 IV PPE | 2.00 | 5.00 | — |
| 0.33 IV FAPPE | — | — | — |
| 0.33 IV MAPPE | — | — | — |
| 0.12 IV FAPPE | — | — | — |
| 0.46 IV FAPPE | — | — | — |
| glass fiber, aminosilane treated | 20.00 | 20.00 | 20.00 |
| glass fiber, epoxysilane treated | — | — | — |
| Properties | | | |
| Flexural modulus (MPa) | 3300 | 3590 | 2382 |
| Flexural stress at yield (MPa) | 78.5 | 90.2 | 65.9 |
| Flexural stress at break (MPa) | 76.5 | 85.5 | 43.8 |
| Heat deflection temperature (° C.) | 82.2 | 87.5 | 79.8 |
| Notched Izod impact strength (J/m) | 130.0 | 127.0 | 61.6 |
| Tensile stress at yield (MPa) | 58.3 | 64.6 | 50.9 |
| Tensile stress at break (MPa) | 58.1 | 62.3 | 50.9 |
| Tensile elongation at break (%) | 2.7 | 2.7 | 2.1 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All ranges disclosed herein are inclusive of the endpoints, and the endpoints are combinable with each other.

All cited patents, patent applications, and other references are incorporated herein by reference in their entirety.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

1. A composition, comprising:
an amorphous poly(alkenyl aromatic) resin;
an acid-functionalized poly(arylene ether); and
an aminosilane-treated inorganic filler.

2. The composition of claim 1, wherein the amorphous poly(alkenyl aromatic) resin comprises at least 25 percent by weight of structural units derived from an alkenyl aromatic monomer of the formula 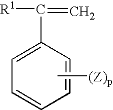
wherein R¹ is hydrogen, C₁-C₈ alkyl, or halogen; each occurrence of Z is independently vinyl, halogen, or C₁-C₈ alkyl; and p is 0, 1, 2, 3, 4, or 5.

3. The composition of claim 1, wherein the amorphous poly(alkenyl aromatic) resin comprises a rubber-modified polystyrene.

4. The composition of claim 1, wherein the amorphous poly(alkenyl aromatic) resin comprises an atactic homopolystyrene.

5. The composition of claim 1, wherein the amorphous poly(alkenyl aromatic) resin comprises a block copolymer of an alkenyl aromatic compound and a conjugated diene.

6. The composition of claim 1, wherein the amorphous poly(alkenyl aromatic) resin comprises a hydrogenated block copolymer of an alkenyl aromatic compound and a conjugated diene.

7. The composition of claim 1, wherein the amorphous poly(alkenyl aromatic) resin comprises a styrene-(ethylene-butylene)-styrene triblock copolymer.

8. The composition of claim 7, wherein the styrene-(ethylene-butylene)-styrene triblock copolymer has a styrene content of about 25 to about 90 weight percent.

9. The composition of claim 7, wherein the styrene-(ethylene-butylene)-styrene triblock copolymer has a styrene content of about 40 to about 90 weight percent.

10. The composition of claim 1, comprising about 10 to about 98 weight percent of the amorphous poly(alkenyl aromatic) resin, based on the total weight of the composition.

11. The composition of claim 1, wherein the acid-functionalized poly(arylene ether) is the reaction product of a poly(arylene ether) and an acid compound selected from (a) aliphatically unsaturated acid compounds comprising at least one carboxylic acid or anhydride group and at least one carbon-carbon double bond or carbon-carbon triple bond, and (b) polyfunctional acid compounds having the structure
(R³O)R²(COOR⁴)ₙ
wherein R² is a linear or branched chain, saturated aliphatic hydrocarbon having a valence of (n+1) and 2 to 20 carbon atoms; R³ is hydrogen or an alkyl, aryl, or acyl group having 1 to 10 carbon atoms; each R⁴ is independently hydrogen or an alkyl or aryl group having 1 to 20 carbon atoms; n is greater than or equal to 2; wherein (OR³) is alpha or beta to a carbonyl group; and wherein at least two carbonyl groups are separated by 2 to 6 carbon atoms.

12. The composition of claim 11, wherein the acid compound is selected from fumaric acid, maleic acid, maleic anhydride, citric acid, malic acid, agaricic acid, itaconic acid, itaconic anhydride, and combinations thereof.

13. The composition of claim 11, wherein the acid compound is selected from fumaric acid, maleic acid, maleic anhydride, itaconic acid, itaconic anhydride, and combinations thereof.

14. The composition of claim 11, wherein the acid compound comprises fumaric acid.

15. The composition of claim 11, wherein the poly(arylene ether) comprises a plurality of structural units of the formula 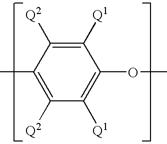
wherein for each structural unit, each Q¹ is independently halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms; and each Q² is independently hydrogen, halogen, primary or secondary C₁-C₈ alkyl, phenyl, C₁-C₈ haloalkyl, C₁-C₈ aminoalkyl, C₁-C₈ hydrocarbonoxy, or C₂-C₈ halohydrocarbonoxy wherein at least two carbon atoms separate the halogen and oxygen atoms.

16. The composition of claim 11, wherein the poly(arylene ether) is selected from poly(2,6-dimethyl-1,4-phenylene ether), poly(2,6-dimethyl-1,4-phenylene ether-co-2,3,6-trimethyl-1,4-phenylene ether), and mixtures thereof.

17. The composition of claim 1, wherein the acid-functionalized poly(arylene ether) comprises about 0.05 to about 10 weight percent of acid functionality.

18. The composition of claim 1, wherein the acid-functionalized poly(arylene ether) has an intrinsic viscosity of about 0.06 to about 0.6 deciliters per gram, measured at 25° C. in chloroform.

19. The composition of claim 1, wherein the acid-functionalized poly(arylene ether) has an intrinsic viscosity of about 0.12 to about 0.46 deciliters per gram, measured at 25° C. in chloroform.

20. The composition of claim 1, comprising about 0.5 to about 40 weight percent of the acid-functionalized poly(arylene ether), based on the total weight of the composition.

21. The composition of claim 1, wherein the aminosilane-treated inorganic filler comprises a filler selected from glass fibers, glass spheres, glass flakes, wollastonite, silica, boron-silicate powders, quartz, alumina, magnesium oxide, talc, mica, kaolin, aluminum trihydrate, magnesium hydroxide, and combinations thereof.

22. The composition of claim 1, wherein the aminosilane-treated inorganic filler comprises an inorganic filler surface treated with an aminosilane, wherein the aminosilane comprises at least one primary, secondary, or tertiary amine group, and at least one C₁-C₆ alkoxy group.

23. The composition of claim 1, wherein the aminosilane-treated inorganic filler comprises an inorganic filler surface treated with an aminosilane selected from γ-aminopropyltriethoxysilane, γ-aminopropyltrimethoxysilane, N,β-(aminoethyl)-γ-aminopropyltrimethoxysilane, N,β-(aminoethyl)-γ-aminopropylmethyldimethoxysilane, N,β-(aminoethyl)-γ-aminopropyltriethoxysilane, γ-aminopropylmethyldiethoxysilane, γ-aminopropylmethyldimethoxysilane, and combinations thereof.

24. The composition of claim 1, wherein the aminosilane-treated inorganic filler comprises an inorganic filler surface treated with γ-aminopropyltriethoxysilane.

25. The composition of claim 1, comprising about 1 to about 80 weight percent of the aminosilane-treated inorganic filler, based on the total weight of the composition.

26. The composition of claim 1, further comprising an unfunctionalized poly(arylene ether).

27. The composition of claim 1, further comprising an additive selected from plasticizers, impact modifiers, mold release agents, colorants, thermal stabilizers, light stabilizers, antioxidants, flame retardants, drip retardants, antiblocking agents, antistatic agents, blowing agents, and combinations thereof

28. A composition, comprising:
an amorphous poly(alkenyl aromatic) resin selected from atactic homopolystyrenes, rubber-modified polystyrenes, and styrene-(ethylene-butylene)-styrene triblock copolymers;
an acid-functionalized poly(arylene ether); wherein the acid-functionalized poly(arylene ether) is the reaction product of a poly(arylene ether) and an acid compound selected from maleic acid, maleic anhydride, fumaric acid, itaconic acid, itaconic anhydride, and combinations thereof; and
aminosilane-treated glass fibers.

29. A composition, comprising:
about 30 to about 94 weight percent of an amorphous poly(alkenyl aromatic) resin selected from atactic homopolystyrenes, rubber-modified polystyrenes, and styrene-(ethylene-butylene)-styrene triblock copolymers;
about 1 to about 20 weight percent of an acid-functionalized poly(arylene ether); wherein the acid-functionalized poly(arylene ether) is the reaction product of a poly(arylene ether) and an acid compound selected from maleic acid, maleic anhydride, fumaric acid, itaconic acid, itaconic anhydride, and combinations thereof; and
about 5 to about 50 weight percent of aminosilane-treated glass fibers;
wherein the composition is substantially free of polyamide.

30. An article comprising the composition of claim 1.

31. The article of claim 30 comprising a film, sheet, molded object or composite having at least one layer comprising the composition.

32. A method of preparing a thermoplastic composition, comprising:
blending
an amorphous poly(alkenyl aromatic) resin,
an acid-functionalized poly(arylene ether), and
an aminosilane-treated inorganic filler
to form an intimate blend.

33. A method of preparing a thermoplastic composition, comprising:
melt blending
a poly(arylene ether) resin, and
an acid compound comprising at least one carboxylic acid
group and at least one carbon-carbon double bond
to form an acid-functionalized poly(arylene ether); and
blending
the acid-functionalized poly(arylene ether),
an amorphous poly(alkenyl aromatic) resin, and
an aminosilane-treated inorganic filler
to form an intimate blend.

34. The method of claim 33, wherein said melt blending a poly(arylene ether) resin and an acid compound further comprises blending a free radical initiator.
